(19) United States
(12) Patent Application Publication
(10) Pub. No.: US 2006/0232578 A1
(43) Pub. Date: Oct. 19, 2006

(54) Collapsible portable display

(76) Inventor: Silviu Reinhorn, Mevaseret Zion (IL)

Correspondence Address: SUGHRUE MION, PLLC, 2100 PENNSYLVANIA AVENUE, N.W., SUITE 800, WASHINGTON, DC, 20037, US

(21) Appl. No.: 11/166,964

(22) Filed: Jun. 27, 2005

Related U.S. Application Data
(60) Provisional application No. 60/637,468, filed on Dec. 21, 2004.

(51) Int. Cl. G09G 5/00

(52) U.S. Cl. 345/211

(57) ABSTRACT

A collapsible portable video display is provided, which incorporates a mini-projector, a folding mirror, and a rear projection foldable screen. In one type of implementation the display is incorporated into a mobile device, such as a cellphone, mobile DVD player, etc. In other type of implementation the display device is a stand-alone device having inputs for video and audio signals.

### REFERENCE TO RELATED APPLICATIONS

This application is a continuation of, and claims priority from, Provisional Patent Application Ser. No. 60/637,468, filed Dec. 21, 2004.

### FIELD OF THE INVENTION

The invention relates to portable electronic devices such as cellular phones, personal digital assistance (PDA), portable DVD players, MP3/MP4 players, notebook computers, etc., having a video display. More specifically, the invention relates to an improvement in the video display of portable electronic devices.

### BACKGROUND

Various portable electronic devices that include a video display exist in the art. Examples of such devices include cellular phones, personal digital assistance (PDA), portable DVD players, laptops, pocket PC, MP4 players, etc. Additionally, new devices and new applications continue to be developed and offered to the public. For example, the new generations of cellular technology, 3G and beyond, enable the broadcast of large amount of data in the mobile network, such as full internet connection and TV channels. However, since portable devices are required to be light and compact, their display size is limited, usually on the order of 1.5″-2.5″ diagonal length. Such displays are appropriate for brief textual messages and low resolution graphics, but not for prolonged view of visual display.

Indeed, because of the limited display size, it is very difficult to watch TV shows and regular internet pages on current portable devices, especially mobile “smart phones” and the likes. Specifically, it is almost impossible to read most text that accompany a TV show on a conventional 1.5″-2.5″ display size. Similarly, WEB pages cannot be displayed in full format on a 1.5″-2.5″ display size, but rather the user needs to scroll to see various parts of the page. Even for the part of the webpage that is displayed, the text appears very small and is hard to read. Because of that, in some systems the information that is broadcast through the mobile network is modified to match the limited display size of the cell phones, PDA, etc. For examples, there are special portals on the web for cell phones (WAP), which transfer very limited amount of information that can be properly displayed on limited size screens.

As can be understood, there is no technological limitation to broadcast of complete web sites or video programs through various mobile networks. However, from the user's perspective, the usefulness of such transmission diminishes due to the inability to view the information on the small screen. Accordingly, there is a need for a system that will enable a large display of video information, but without increase in the size of the portable devices.

### SUMMARY

Embodiments of the present invention provide an enlarged video display for portable devices, without having to enlarge the size of such devices.

In one aspect of the invention, a collapsible portable display (CPD) is provided. The CPD can operate in any of the standard display modes (VGA, QVGA, SVGA, XVGA, etc.). In one embodiment the CPD is a stand alone apparatus that is connectable to any of the portable devices having the capability to process video signals (i.e., a signal relating to the production of images on video displays). In another embodiment the CPD is integrated into a portable device. In one particular example, the CPD is integrated into a mobile phone. The combination of such a CPD, whose size might be in the range of 5″-9″, with conventional mobile devices will enable the operator to connect to the internet and view conventional website in standard HTML format, rather than reduced WAP format. Due to the increase size of the screen of the CPD, website font will be readable and scrolling may be eliminated or drastically reduced. Similarly, the large display size of the CPD enables viewing TV shows, including legible display of captions and subtitles.

In various embodiments of the invention, when the CPD is not in use it can be folded into a small size for stowage. In some described embodiments the CPD is foldable into the portable device body itself. In such embodiments the addition of the CPD only minimally increases the size of the portable device, if at all. Additionally, in such embodiments when the CPD is folded the mobile device can be used in the normal way.

The CPD may also be used as a display for laptops or portable DVD screens. While the CPD can be used in conjunction with a conventional laptop computer so as to provide lighter and cheaper display, according to one embodiment a “screenless” laptop is provided, which may be coupled to the CPD. According to this embodiment, when the screenless laptop is used in a non-mobile environment it is connected to a docking station, which, in turn, is connected to a conventional display or to a CPD. However, when used in a mobile environment, the laptop is connected to a CPD which is more compact, has lower power consumption and enables more working hours with the laptop battery.

Another feature of the invention is that it provides an increased contrast as compared to conventional front projection displays. That is, in a conventional projection display the image is projected on the screen from the front side, i.e., from the same side facing the viewer. The projected image then reflects from the screen and is viewed by the viewer. However, any ambient light that hits the screen is also reflected and reaches the viewers eyes. Consequently, the viewer experiences reduced image contrast. On the other hand, according to embodiments of the inventive CPD, the image is projected onto the screen from the backside. As a result, the amount of light of the projected image that reaches the viewer's eyes is drastically increased. Additionally, according to other embodiments of the invention, the CPD is made of two layers, a diffusive material layer that enables viewing of the projected image, and an ambient light absorbing layer, which reduces ambient light reflection to the viewer's eye, thereby enhancing the image contrast.

In yet another embodiment of the inventive CPD is connected to a PDA. Notably, current PDA's incorporate advanced processors that are capable of running full office programs, such as word processing and spreadsheet programs. Current PDA's also include increased memory size and capability for memory expansion. Therefore, various vendors currently offer collapsible keyboards for use with such PDA's. However, even with a full featured PDA connected to a collapsible keyboard it is still difficult to work on general office programs because the conventional PDA screen is simply too small for such work. Consequently, contrary to many predictions, PDA's have yet to replace laptops and most users still carry a laptop even if they posses an advanced PDA. However, using the inventive CPD in conjunction with a foldable keyboard the PDA can be used for general office tasks and may indeed replace the laptop.

According to one aspect of the invention, a portable video projection device is provided which comprises a mini-projector receiving video signals and projecting images therefrom; a collapsible screen comprising a diffusive material; and an image reflection mirror reflecting the images onto the backside of the collapsible screen. The collapsible screen may comprise a foldable frame or a spring loaded roller. The mini-projector may be extendable from the projection device for image projection and retractable into the projection device for storage. Alternatively, the mini-projector includes a projection lens which is extendable from the projection device for image projection and is retractable into the projection device for storage. The portable projection device may further include a foldable camera. According to one aspect the image reflection mirror is extendable from the projection device for image projection and is retractable into the projection device for storage. The portable projection device may be a stand alone device or may be one of a mobile phone, a PDA, a digital video player, and a digital music player.

According to another aspect of the invention, mobile phone is provided which comprises a phone casing, a mini-projector housed in the casing and projects video images; a collapsible screen coupled to the casing; and a foldable mirror reflecting the video images from the mini-projector onto backside of the collapsible screen. The collapsible screen may be structured in the form of a flexible diffusive sheet and may include a foldable frame. The collapsible screen may be also be provided with a roller. The mini projector may be selected from LCD, LCOS, DLP, and OLED projectors. The mobile phone may further include a camera.

According to yet another aspect of the invention, a portable video projection device is provided, comprising: a keyboard having a signal connector for receiving video signals from a portable device; a mini-projector housed in the keyboard, the mini-projector receiving the digital video signals and projecting video images therefrom; and a collapsible screen comprising a diffusive material; an image reflection mirror reflecting the images onto the backside of the collapsible screen. The collapsible screen may comprise a flexible diffusive sheet. The mini-projector may comprise a projection lens, the projection module being extendable from the projection device for image projection and is retractable into the projection device for storage. The image reflection mirror is extendable from the projection device for image projection and is retractable into said projection device for storage. The mini projector may be any one of LCD, LCOS, DLP, and OLED.

### BRIEF DESCRIPTION OF THE DRAWINGS

Other features and advantages of the invention will appear from the following description, where:

FIGS. 1A and 1B are schematics of an embodiment of the invention implemented in a mobile phone.

FIG. 2 depicts another embodiment of the invention implemented in a mobile phone.

FIGS. 3A and 3B depict other embodiments of the invention wherein image projection is done from the bottom of the device; while FIG. 3C depicts a device in a folded configuration according to an embodiment of the invention.

FIGS. 4A and 4B are side-cut view and perspective view, respectively, of another embodiment of the invention.

FIG. 5 depicts an example of the use of the rolled screen to obtain a screen size that is much larger than the portable device itself.

FIGS. 6A and 6B depict embodiments structured to make use of a small portable device, such as a PDA or mobile player, such as an iPOD.

FIG. 7 depicts an embodiment of a mini-projector 500 of the transmissive LCD matrix type.

FIG. 8 depicts an embodiment of the reflective-type projector.

FIG. 9 depicts another embodiment of a mini projector using RGB light sources.

FIGS. 10A-10D depict various embodiments for the folding screen.

The invention is described herein with reference to particular embodiments thereof, which are exemplified in the drawings. It should be understood, however, that the various embodiments depicted in the drawings are only exemplary and may not limit the invention as defined in the appended claims.

### DETAILED DESCRIPTION

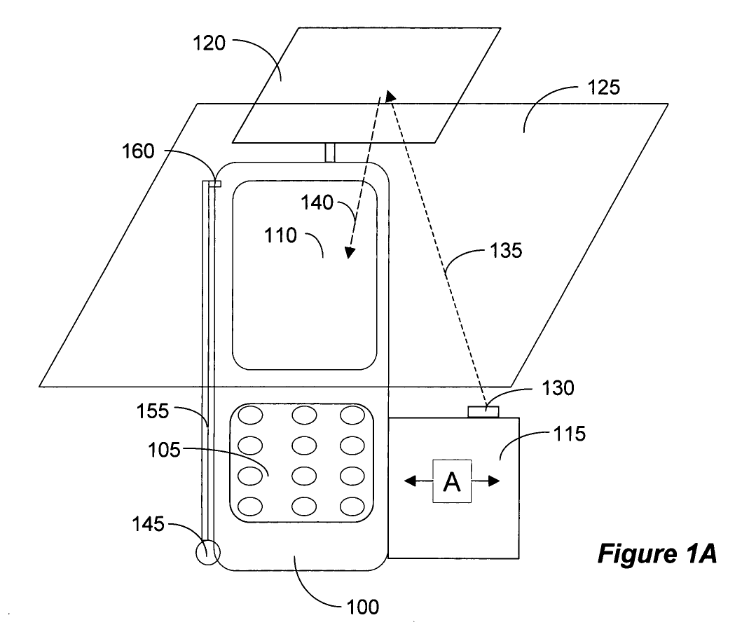

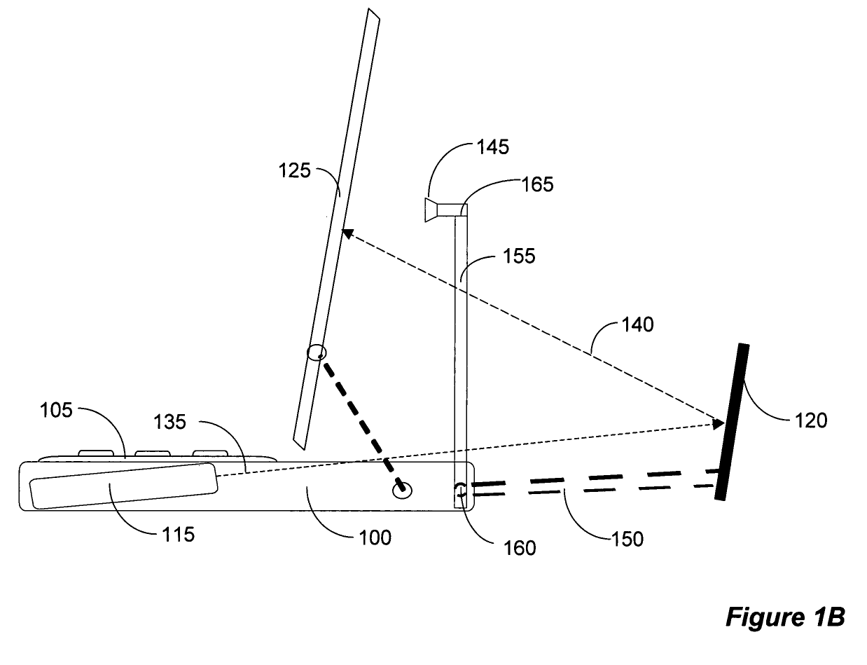

FIGS. 1A and 1B are schematics of an embodiment of the invention implemented in a mobile phone 100. Mobile phone 100 includes a keypad 105 and may include a conventional screen 110, such as an LCD screen. While in this embodiment the keypad 105 is shown as a dial keypad, it should be understood that any keypad may be used, e.g., conventional QWERTY keypad or other typing keypad. Additionally, the keypad may include function buttons, such as “call,” “off,” “mail,” “web,” etc., as is provided in many Palm™ or PocketPC™ based smart phones. When screen 110 is provided, it can be used for normal operation of the phone, such as placing calls, SMS, etc.

A feature of this embodiment of the inventive CPD is the provision of an additional display capability which, while providing an enlarged viewing area, minimizes the overall size of the phone. The additional display capability is enabled by the mini projector 115, the return mirror 120, and the collapsible screen 125. In FIG. 1 the collapsible screen is shown transparent. This is for two reasons, first, to enable the reader to better understand the drawing by showing the parts of the apparatus that would normally be covered by the screen in the shown angle and, to symbolizes the characteristics of the screen for portraying on the front side an image that is projected from the rear. This will be explained further in the description below. Also, as can be understood, the return mirror 120 and collapsible screen 125 may be shifted so that they are normally aligned with the mini projector 115. Alternatively, the mini projector 115 includes provisions for digitally correcting the projected image so that it is projected on the screen in a proper rectangular format. Such a correction can be done in a manner conventionally done in current commercial projectors for correcting image projection in an angle to the screen.

In the particular embodiment of FIG. 1, the mini projector 115 is slideable into the mobile phone's body for stowage, as depicted by arrow A. Mini projector 115 includes a projection lens 130 for projecting an image onto mirror 120, as shown by broken arrow 135. Alternatively, the projection lens is inside the mini projector 115 and element 130 is a transparent window for projective the image. Mirror 120 then reflects the projected image onto the collapsible screen 125, as depicted by arrow 140. Mirror 120 is also provided with a folding mechanism so that it can be folded away when not in use. By using the folding mechanism to deploy the mirror, the optical path can be enlarge to accommodate projection on a large screen. Therefore, when the device body itself is to be maintained small, it is advantageous to provide a folding mirror on an arm enabling increasing the length of the optical path of image projection.

In the embodiment of FIG. 1 the mobile phone includes an optional folding camera 145. While any type of conventional camera may be used, such as the integrated camera conventionally provided on current phones, the conventional placement of camera may interfere with the screen and therefore prevent the use of a camera for video conference. The provision of the folding camera 145 provides the capability to conduct video conference when the screen is deployed. In this embodiment a CCD camera 145 is mounted onto a base arm 155 that is higher than the screen 125 or is besides it. The wires to the CCD camera may be threaded within the arm 155. The arm 155 is connected to the phone 100 through joint 160, which enables the folding of the arm parallel to the phone's body. In FIG. 1A the arm 155 is shown in its folding position, while in FIG. 1B the arm is shown in its upright position. The CCD camera 145 is mounted on top of its arm with the aid of a 360° joint 165, that enables the camera 145 to be rotate to the desired orientation. The rotation can be motorized or manual. Using this embodiment the user may capture video or still images and can participate in a video conference.

The collapsible screen may be provided in various implementation which will enable folding the screen to minimize its size while it is not in use. For example, the screen can be folded or rolled so it is out of the way when not in use. Various illustrations of such folding and storage are discussed below. The provision of the collapsible screen enables the phone to be used in a conventional manner to place calls when the screen is folded. That is, when the CPD screen is folded, the conventional display of the phone, such as the conventional LCD display, is used in a normal manner, such as to place calls, send and receive SMS, display phone settings, etc. On the other hand, when the CPD is deployed, the phone can be used for video display, such as for web surfing, image viewing, movie viewing etc. Accordingly, for example, a video driver may be provided which is inactivated during normal mode in order to conserve battery charge. Once the screen is deployed, the video driver and the mini projector are activated, while the conventional LCD display is de-activated. The activation and de-activation of the video driver and mini projector can be done automatically by, for example, an actuator actuated by the deployment of the screen, the mirror, or the mini projector. When the CPD is deployed, audio can be provided by the phone's speaker or via headphones. On the other hand, normal phone reception may still be enables, so that the user may use the CPD to, for example, surf the web, while simultaneously converse on the phone.

As can be understood from FIGS. 1A and 1B, in this embodiment a rear illumination projector is used. A rear illumination projector generally provides higher contrast than front illumination, as explained above. To implement the rear illumination arrangement, in this embodiment the screen 125 is made of a diffusive material such as the LSD® light shaping diffuser film commercially available from POC of Torrace, Calif. The screen may be flexible and can be attached to a hollowed flexible black net. The diffusive layer scatters the image light towards the viewer's eyes. The hollowed black net is used for reducing the background illumination reflected from the screen, in order to maximize the screen contrast. The flexible screen can be attached to a collapsible frame that stretches the screen in operation mode and can be folded when not in use.

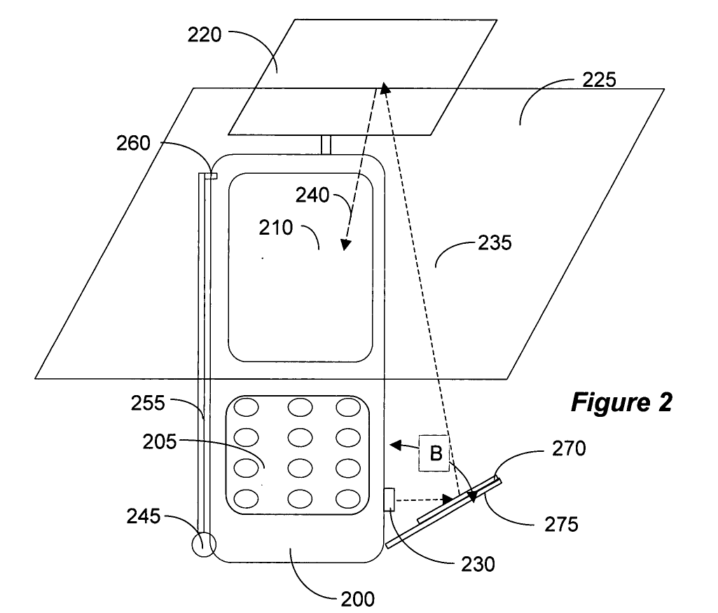

FIG. 2 depicts another embodiment of the invention implemented in a mobile phone. For clarity, the embodiment of FIG. 2 is shown as a modification of the embodiment of FIGS. 1A and 1B, and similar elements are noted with the same numerals, except that in FIG. 2 they are in the two-hundred series. Notably, in the embodiment of FIG. 2 the mini projector (not shown) is integrated into the body of the phone 200 and does not slide out. Instead, a projection mirror 230 is provided on the side of the phone so as to project an image into a folding mirror 270 which, in turn, project the image onto folding mirror 220. Mirror 270 is mounted on arm 275, which can be folded when not in use as depicted by arrow B. As can be understood, while this embodiment is described with reference to a mobile phone, it can be implemented with any portable device.

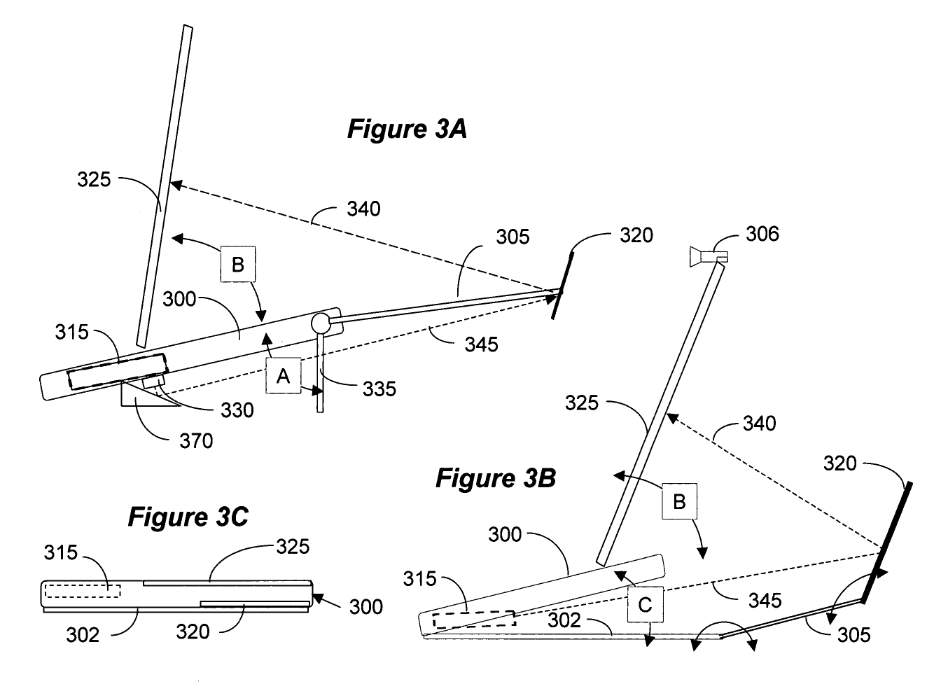

FIGS. 3A and 3B depict two embodiments of the invention which can be implemented in any mobile device 300, for example, laptop, keyboard or collapsible keyboard, mobile DVD player, cell phone, iPod, etc. In these embodiments, the image is projected from the bottom of the device. Referring to the embodiment of FIG. 3A, the mini projector 315 is integrated into the body of the mobile device 300 and has its projection lens 330 pointed downwards. When the device is operated with the inventive screen, one side of the device 300 is elevated by, for example, foldable support 335. Foldable support 335 can be swung into an open or close position as depicted by arrow A. Once the support 225 is swung into an open position and the backend of the mobile device 300 is elevated, a projection mirror is 370 is deployed from the underside of device 300 so as to project the image from the projection lens 330, as depicted by broken arrow 345. Another folding mirror 320 reflects the projected image onto folding screen 325, as shown by broken arrow 340. Folding mirror 320 is deployed and retracted by means of arm 305, while folding screen can be folded as shown by arrow B. Of course, other methods for folding the screen may be used, as is described in more details further below. The deployment of the screen can be done manually, having spring loading, motorized, etc.

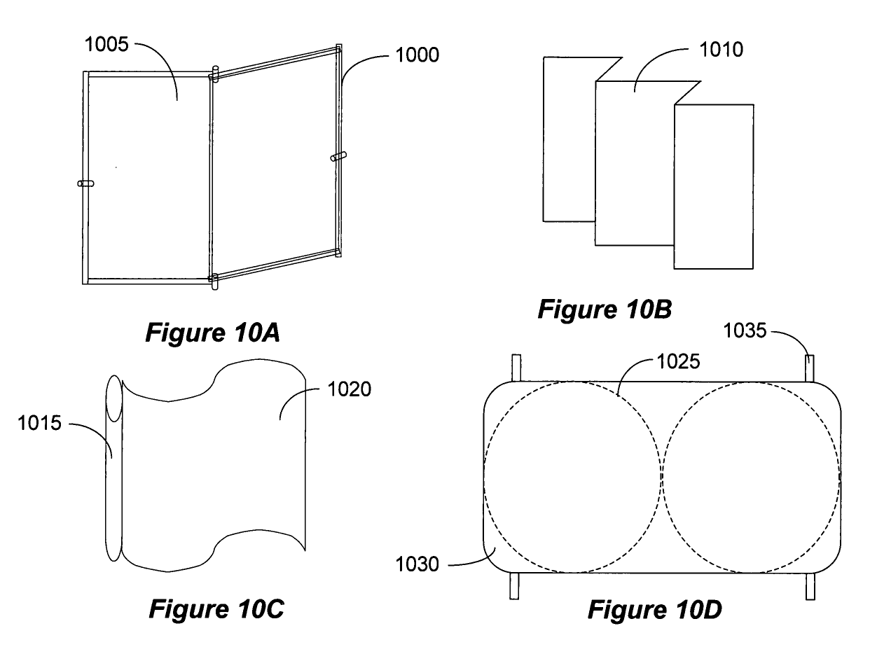

Turning to the embodiment of FIG. 3B, device body 300 has a back cover 302 that can be opened as shown by arrow C. In its deployed position, cover 302 is used as a base for the device 300, enabling deployment of the mini projector 315 so as to project the image from the bottom of the device 300. The mirror 320 is also deployed by means of arm 305 (See curved arrows indicating folding direction) so as to increase the length of the optical path. The camera 306 is shown attached to the top of the screen 325, although other arrangements may be used. FIG. 3C depicts the device 300 in its folding configuration, exemplifying the compactness of the solution when not deployed. Mirror 320 is shown in its folded position, with arm 302 being retracted and secured, e.g., via a clip, to the back of device 300. The mini-projector 315 is shown in its stored orientation; however, it should be appreciated that the mini-projector may be stationary and optical elements can be used to project the image when the device is deployed, as shown by, for example, FIG. 3A. The screen 325 may be folded in many configurations, some of which are illustrated in FIGS. 10A-10D. For illustration, in FIG. 3C the screen 325 is shown folded and secured to the side of device 300.

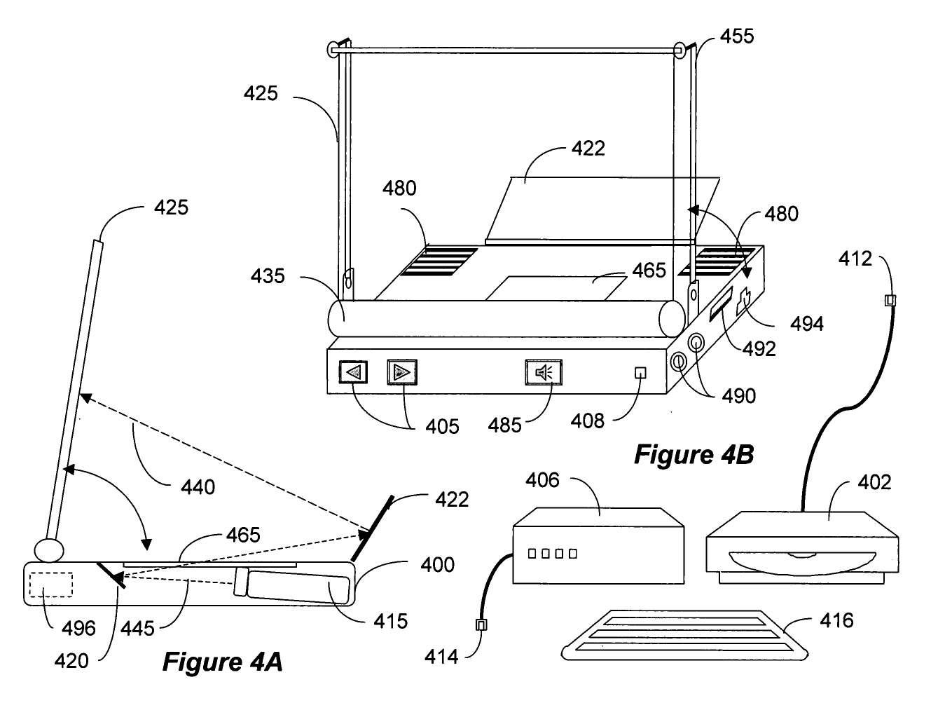

FIGS. 4A and 4B are side-cut view and perspective view, respectively, of another embodiment of the invention. In this embodiment mobile device 400 can be either a stand-alone mobile rear projection screen or a mobile application device, such as e.g., a mobile video player, a mobile computing device, a PDA, smart phone, etc., having the inventive rear projection screen. Such mobile application devices and mobile computing devices can also be referred to in general as mobile consumer appliances. In its stand-alone variation, the rear projection device 400 comprises a mini projector 514, projection mirrors 420 and 422, and folding screen 425, all of which will be described in more details below. The device 400 may be battery operated or connected to external power source. The device 400 may also be connected to various display sources, such as computer 402, for example an Apple Mac Mini, or a variety of video players 406, such as a DVD player, an MP4 player, etc. The connection may be made using, e.g. a USB connector 492, a FireWire connector 494, IR receiver 408, BlueTooth Transceiver 496, etc. For illustration purposes, computer 402 are illustrated as having connector 412, while the video player 406 is illustrated as having connector 414. Further utility may be achieved by also connecting keyboard 416 to the device 400. Keyboard 416 may be conventional keyboard having, for example, a USB connector, or a conventional wireless keyboard using, e.g., IR transmission. Note that neither the computer 402, the video device 406, nor keyboard 416, are drawn to scale with respect to the projector 400.

On the other hand, projection device 400 may be implemented as a mobile video player device by incorporating in device 400 a CDROM, a DVD, a hard drive, etc. Conversely, projection device 400 could be implemented as a laptop PC having such a collapsible screen and mini-projector embedded in its body instead of, or in addition to, the conventional LCD display. In this manner, the device 400 can be self-contained and enable video viewing using the inventive collapsible screen. For that purpose, a user interface in the form of operation buttons 405, such as “play” “pause” etc., can be provided on the device 400. Regardless of whether device 400 incorporates a video player, it may include speakers 480, in which case speaker controls 485, such as volume and mute, can also be provided. As is shown in FIGS. 4A and 4B, device 400 also may include inputs 490 for inputting or outputting external audio and video signals. Again, this can be provided regardless of whether the device 400 includes internal video player.

As can be understood, one advantage of the inventive display is that the device itself may be much smaller than the deployed screen size. For example, the body of the device may be reduced to a size of a small cellphone, while the size of the deployed screen may be similar to a size of a laptop computer screen. To accomplish such an enlargement of the projected image, the optics may be folded in order to increase the optical path. In the example of FIGS. 4A and 4B the optics is folded twice. As shown in the side-cut view of FIG. 4A, the mini-projector 415 is provided internally to the device 400, at the rear side thereof. A first mirror 420 is provided in the front side of the device and folds the optical path back to the rear towards mirror 422 through window 465. Mirror 422 folds the optical path a second time, towards the screen 425. As can be understood, mirror 422 is larger than mirror 420, since the image projected onto mirror 422 is larger than that projected onto mirror 420. Therefore, mirror 422 may need to be folded out of device body 400, or may need to be deployed on a folding arm in a manner shown in other embodiments in this description.

Screen 425 is a foldable rear projection screen. While any foldable rear projection screen can be used, the embodiment of FIGS. 4A and 4B use a roll-up type screen. The screen itself is made of a diffusive material such as the LSD® diffuser film commercially available from POC. Such material is suitable for rear projection and would provide increased contrast when compared to front projection systems. According to one embodiment of the invention, the screen is made of two layers that may be attached together by conventional methods, such as lamination, etc. The first layer is a diffusive material for image display, and the second layer is a black ambient light absorbing layer. The absorbing layer should face the user. A black ambient light absorbing layer is conventionally available and is conventionally used for increasing image contrast by reducing ambient light, especially in rear projection applications. While such a layer may attenuate the image projected from the rear, is drastically attenuates any ambient light reflection, as the ambient light has to travel through the layer twice before reaching the viewer's eyes. Further explanation of the operation and use of such a layer can be found in various product literatures available from 3M corporation with respect to their video screen products, such as the Vikuiti™ Extended Resolution Video Screens.

In the stowed position the screen is rolled inside roller 435, and in the deployed position the screen is held upright by foldable post 455. The screen is again shown transparent so as not to obscure to the reader the elements behind it. However, the screen need not be completely transparent as long as it allows rear image projection by, for example, diffracting the projected light towards the user eyes. When the ambient light absorbing layer is used, the screen may appear black when viewed from the front.

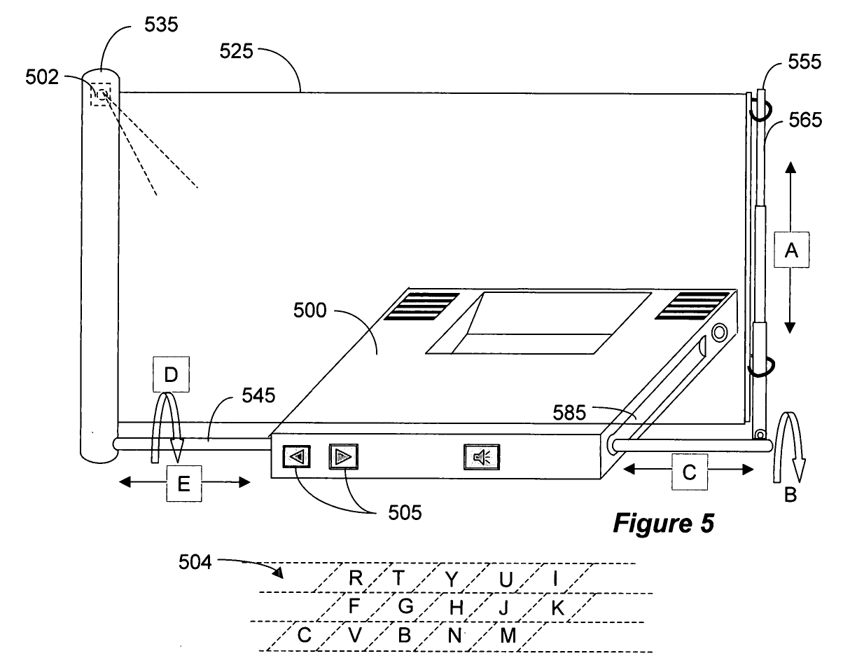

FIG. 5 depicts an example of the use of the rolled screen to obtain a screen size that is much larger than the portable device itself; however, as can be understood, other screen styles can be used to provide the same result. In FIG. 5, the portable device 500 may be any of the portable devices that provide video display and incorporates the rear projection arrangement according to any of the various embodiments of the invention. For example, portable device 500 may be the same or similar to device 400 of FIGS. 4A and 4B, except that Device 500 uses only a two legs optical path. As such, the description of the device itself is omitted, and only explanation regarding the foldable screen 525 is provided herein. As shown in FIG. 5, screen 525 is rolled inside encasing 535. For ease of use, the rolling of the screen 525 into encasing 535 is spring loaded, in a manner well known in the art. In its open position, the screen 525 is held taught by post 555. To enable reduction in size, post 555 should be made to fold in some fashion. In the example of FIG. 5 post 555 is collapsible in a manner similar to an antenna, by using several section 565 of varying diameter, and as shown by arrow A. Also, in this particular embodiment, the post 555 is attached to a retractable holder 575, which is rotatable as shown by arrow B and is retractable into the device 400, as shown by arrow C. Using this construction, post 555 can be collapsed and retracted so as to be stored in cavity 585, so as to minimize the overall size of device 500. Encasing 535 is also attached to a retractable holder 545. Holder 545 is rotatable, as shown by arrow D, and can be retracted into the body of device 500, as shown by arrow E. In this manner, in its closed position the screen can be stored in a manner minimizing the size of the portable device 500.

Also shown in FIG. 5 is an optional virtual keyboard system 502. More specifically, the virtual keyboard system 502 projects a keyboard image 404 on any flat surface. The user simply uses the projected image 504 as a keyboard and the system accepts the entry as with conventional keyboard. This is done by triangulating cameras that monitor the user's fingers movement. Additional information regarding virtual keyboard can be obtained from Virtual Devices, Inc., of Allison Park, Pa. While the virtual keyboard is illustrated only with reference to FIG. 5, it may be used in any of the other embodiments described herein.

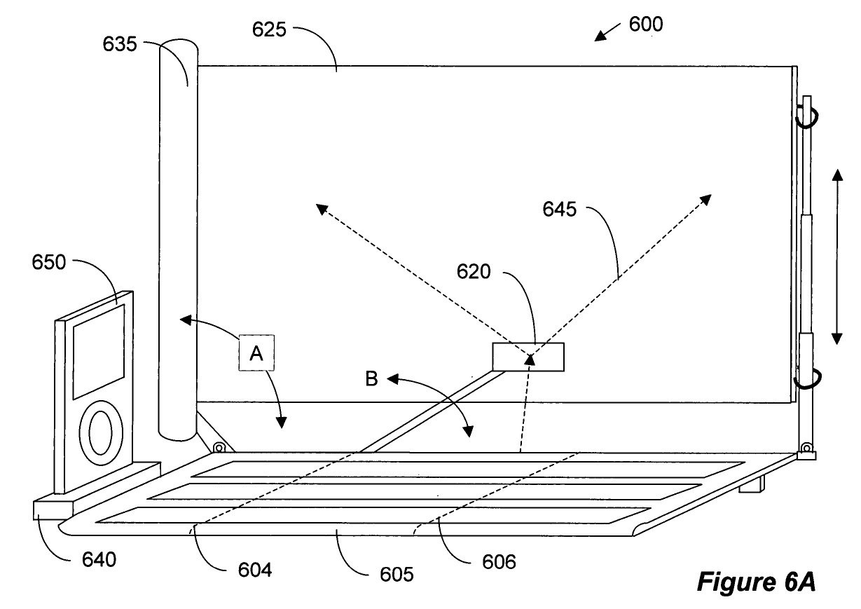

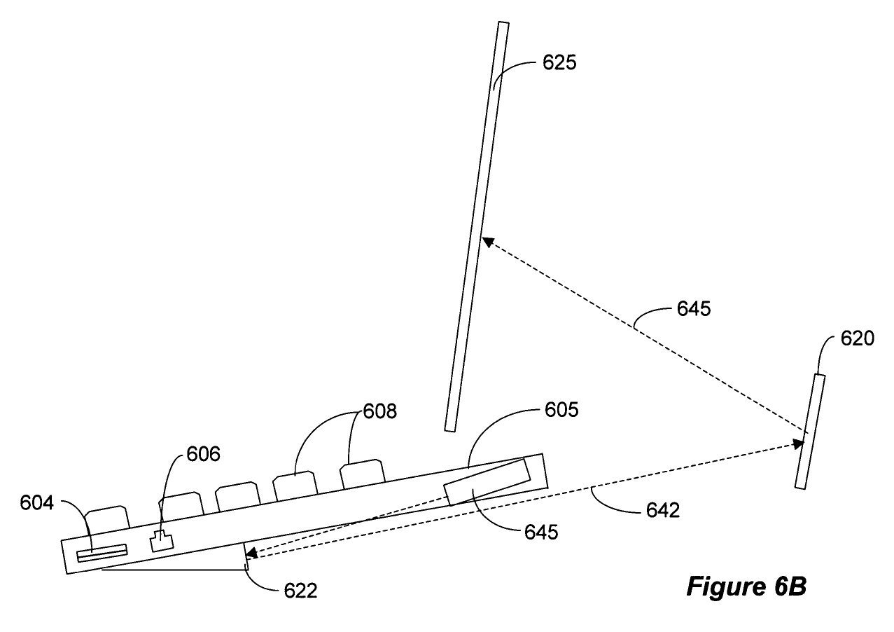

FIGS. 6A and 6B depict an embodiment structured to make use of a small portable device, such as a PDA, e.g. Palm Pilot™ and PocketPC™, or mobile player, e.g., iPOD™. The device may also be used in conjunction with a laptop or a “screenless” computer, such as the Apple Mac Mini. In FIGS. 6A and 6B the arrangement enables use of the small portable device to provide a device of similar capability as a laptop, but of much smaller size. According to this embodiment, the main body of device 600 is provided in the form of an alphanumeric user interface, such as a keyboard 605 having entry or typing keys 608. Although not necessary, the keyboard 605 may be a foldable keyboard using any conventional folding mechanism, as illustrated by broken lines 604, 606. Additionally, the keyboard 605 may be provided with wired connections, such as USB 604, FireWire 606, or wireless connection, such as IR or BlueTooth (not shown), to enable connection to computing devices.

The mini projector 645 is incorporated into the keyboard in a manner suitable for projection of the video images onto the foldable screen. FIG. 6B depicts one embodiment for incorporating the mini projector. However, as can be understood other structures may be used, as well as any embodiments similar to that depicted in FIGS. 3A and 3B. In the embodiment shown in FIG. 6B the optical path is folded twice. The mini projector is mounted at the rear side of the keyboard, facing to its front side, i.e., towards the user. The video image is projected towards first mirror 622, and is reflected therefrom towards mirror foldable mirror 620. The foldable mirror 630 projects the video image onto the screen 625. As can be understood, mirror 422 may also be retractable for storage.

The screen 625 may be constructed in a collapsible manner, similar to any of the embodiments depicted in FIGS. 10A-10D. In this embodiment, the screen 625 is provided in a retractable-roller form, similar to that of FIG. 5. The screen encasing 635 can be folded in a manner shown by arrow A, so as to be stored. The mirror 620 may also be folded for storage, as shown by arrow B.

Device 600 may incorporate docking station 640, such as a sync adapter for iPod, Palm, etc., or may include provisions for connecting a conventional docking station, e.g., a USB or FireWire connectors. Device 600 may also include conventional connectors, such as USB and FireWire, so as to serve computing purposes. The docking station may be used to dock any portable device 650, such as, for example, Palm, PocketPC, or iPOD devices.

In the various embodiments described the mini projector unit is comprised of display matrix that can be a transmissive or reflective LCD matrix, a LCOS matrix, a DLP matrix, an OLED matrix, or any other suitable projection device. In such a projector the image formed on the matrix is rear projected onto a flexible screen with the aid of an imaging lens. While, it is also possible to project the image directly by front projection onto any diffusive surface, a better result can be obtained using rear projection. To enable switching between front and rear projection, the mini projector has a function that selects the projection mode: front or rear. The difference in between the two modes is that the image is inverted horizontally on the display, by electronics means according to the selected display mode. That is, the image is flipped right to left—depending on whether the viewer is viewing the serene from the same side as where the projector is or from the opposite side. To correct for that, a selector can be provided which will cause the mini projector to electronically project a correct or flipped image. This can be done by simply flipping the image signal sent to the projector's matrix.

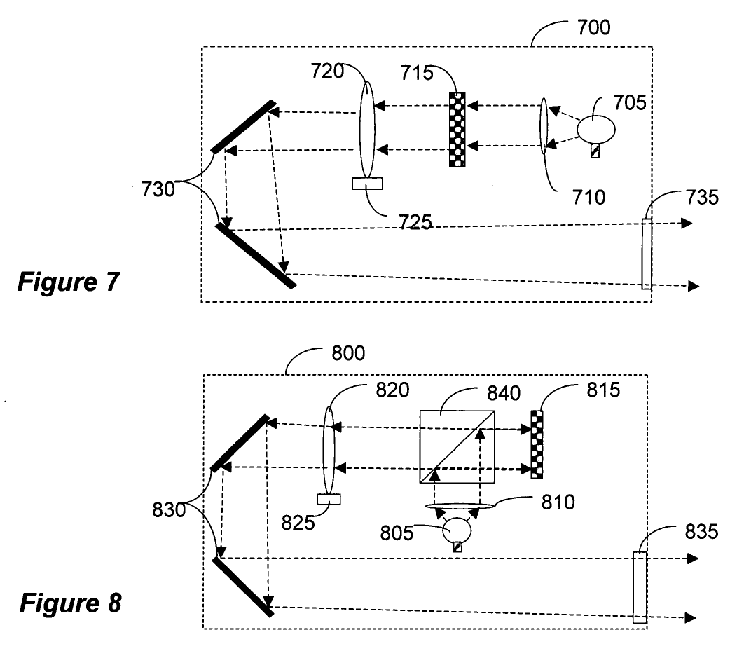

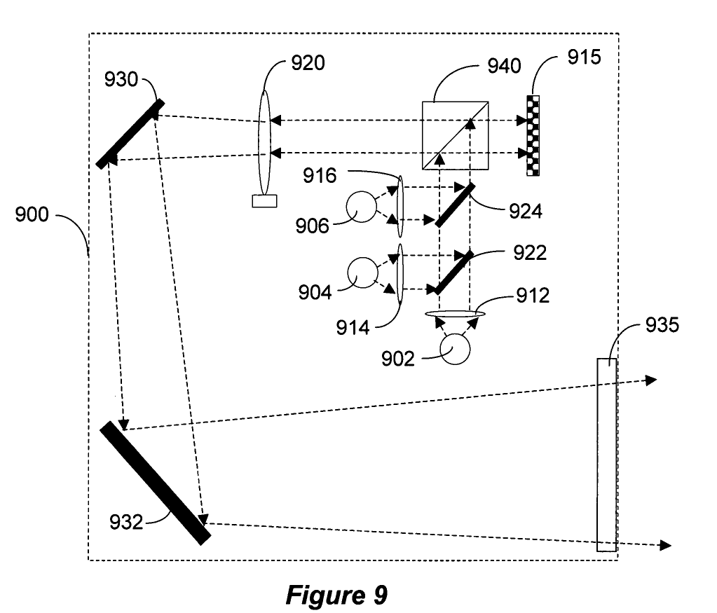

FIG. 7 depicts schematically an embodiment of a mini-projector 700 of the transmissive LCD matrix type. A light source 705, such as an RGB LED or white LED emits light, which is directed by collimating lens 710 onto a matrix 715. As seen in FIG. 7, the display matrix 715 could be a colored LCD (each pixel is divided into three pixels R/G/B) that is illuminated with a white light source 705, such as a high brightness white LED. Alternatively, the LCD can be a mono-chrome device that is illuminated sequentially with RGB colors. This can be done with a single RGB led or with three independent LEDs, combined together as described with respect to the embodiment of FIG. 9 below. The display matrix is driven by the video signal so as to modulate the light and project the image. As explained above, the video signal may be flipped depending on whether the image is projected on a transmissive or reflective screen. The imaging lens 720 shapes the light beam to be projected onto the screen. In this embodiment, the imaging lens 720 is mounted onto a mechanized holder 725 so as to provide focusing adjustment. The mechanized holder 725 can be manually or electrically moved to adjust the focus.

In order to miniaturize the projector, in FIG. 7 the optics is folded using mirrors 730. That is, the imaging lens projects the image onto the first mirror 730, which reflects the light to the second mirror 730, which, in turn projects the image through window 735. The image beam then exits the mini-projector and is used as shown in the various embodiments described herein.

FIG. 8 depicts an embodiment of the reflective-type projector. The reflective type mini projector 800 can operate with a reflective LCD, LCOS or DLP matrix 815. In this embodiment, an additional polarizing beam splitter 840 is needed in order to define efficiently the light paths from the illumination source 805 with that from the reflective display 815 and to the imaging optics 820. The illumination light source 805 could be the same as that described in the transmissive unit embodiment of FIG. 7. In both cases the display matrix 715 or 815 could be a mono-chrome LCD that has triple frame rate, in which each frame is displayed three times, one for each color Red, Green and Blue. For such a display the light source 705 or 805 should be an RGB high brightness LED that can sequentially emit each color, or a series of three independent high brightness LEDs, that have their optical paths combined together with dichroic beam combiners, as depicted in FIG. 9.

FIG. 9 depicts an embodiment of the mini projector 900 that uses three light sources in an RGB arrangement. Projector 900 uses a reflective-type matrix 915, such as an LCD or DLP matrix. The light source is made of three color light source, 902, 904, and 906, that may be, for example, red, green, and blue LED's, respectively. The light from the sources is collimated by collimating lenses 912, 914, and 916, and is combined into a single beam by dichroic beam combiner made of dichroic mirrors 922, 924. The combined beam is reflected towards the matrix 915 by polarizing beam splitter 940. The beam is modulated by the matrix 915 and is reflected through the beam splitter 940 and projection lens 920 towards mirror 930. Mirrors 930 and 932 folds the beam and projects it through window 935.

In the described embodiments the screen brightness should be on the order of 40-100 cd/m². High brightness LEDs, such as RL5-W10015 or RL5-RGB supplied by Superbrightleds Inc., which have a brightness of about 10000 cd, can be used for illuminating the display matrix. Such an LED can illuminate a screen of up to 9″ diagonal, assuming overall illumination efficiency of about 10%. With higher LED brightness larger screen can be displayed. On the other hand, for applications that compactness is not crucial such as CPD embedded into laptop, keyboard, DVD, etc. and there is a need for large screen, it is possible to use more the 3 illumination LEDs in order to obtain the required illumination power.

FIGS. 10A-10D depict various embodiments for the folding screen; however, it should be appreciated that the collapsible screen can be folded in various other ways. FIG. 10A depicts a screen which is foldable in half by means of screen 1005 being mounted onto a frame 1000. Screen 1005 may be flexible or rigid. FIG. 10B depicts a screen 1010 that is foldable in an accordion fashion. Of course, other folding structures may be used. FIG. 10C depicts a rolled screen, similar to that depicted in the embodiment of FIG. 4. Screen 1020 is rolled into roller case 115 using manual (or motorized) rolling, spring loading, motorized rolling, etc. FIG. 10D depicts a screen that is modeled after the design of the car sunshade described in U.S. Pat. No. 4,815,784. Two flexible wire loops 1025 may be folded (not shown) or deployed to an open position as shown. A flexible screen 1030 is attached to the wire loops 1025, and is made to stretch when the wire loops 1025 are deployed. Tabs, such as fabric loops or Velcro™ tabs are provided to enable attaching the deployed screen to a rigid stand.

As such, a portable display system is described. In the view of the above detailed description of various embodiments of the present invention and associated drawings, other modifications and variations will now become apparent to those skilled in the art. For example, all folding/unfolding procedure could be motorized. It should also be apparent that such other modifications and variations may be effected without departing from the spirit and scope of the present invention as set forth in the claims which follow.

1. An integrated mobile phone and video projection device, comprising: a phone casing, a dialing pad provided on said phone casing; a mini-projector housed in said casing and projecting video images; a collapsible screen; and, a retractable image reflection mirror elongating said optical path in an extended position to thereby reflect said video images onto the backside of said collapsible screen.

2. The mobile phone of claim 1, further comprising a video driver and wherein said video driver is activated in a video projection mode of said phone and is deactivated in a normal mode of operation of said phone.

3. The mobile phone of claim 1, wherein said collapsible screen comprises a flexible diffusive sheet.

4. The mobile phone of claim 3, wherein said collapsible screen further comprises an ambient light absorbing layer.

5. The mobile phone of claim 4, wherein said collapsible screen further comprises a foldable frame.

6. The mobile phone of claim 1, wherein said collapsible screen further comprises a roller.

7. The mobile phone of claim 6, wherein said roller is spring loaded.

8. The portable projection device of claim 1, further comprising a foldable camera.

9. The portable projection device of claim 1, wherein said mini-projector comprises a light emitting diode—LED light source and a projection matrix.

10. The portable projection device of claim 9 wherein said LED light source is a high brightness white-light LED.

11. The portable projection device of claim 9, wherein said LED light source comprises an RGB LED arrangement.

12. The portable projection device of claim 11, wherein said RGB LED arrangement comprises a single LED device providing red, green, and blue light sources.

13. The portable projection device of claim 11, wherein said RGB LED arrangement comprises a red LED, a green LED and a blue LED.

14. The portable projection device of claim 8, wherein said projection matrix is one of a reflective LCD, LCOS, and DLP matrix.

15. The portable projection device of claim 8, wherein said projection matrix is a transmissive LCD matrix.

16. The mobile phone of claim 1, wherein said collapsible screen comprises a motorized mechanism for deployment and folding of said screen.

17. An integrated keyboard and video projection device, comprising: a keyboard body having entry keys provided thereon; a mini-projector situated within said keyboard body and projecting video images; a foldable screen mounted onto said keyboard body; and, a projection mirror reflecting said video images onto the backside of said foldable screen.

18. The integrated keyboard and video projection device of claim 17, further comprising a retractable arm supporting said projecting mirror.

19. The integrated keyboard and video projection device of claim 17, wherein said foldable screen comprises a diffusive material.

20. The integrated keyboard and video projection device of claim 19, wherein said foldable screen further comprises an ambient light absorbing layer.

21. The integrated keyboard and video projection device of claim 17, wherein said foldable screen further comprises a flexible wire frame.

22. The integrated keyboard and video projection device of claim 17, further comprising a docking station for at least one of the following: PDA, laptop, mobile phone, smart phone.

23. The integrated keyboard and video projection device of claim 17, further comprising at least one of a USB and FireWire connector.

24. The integrated keyboard and video projection device of claim 17, wherein said mini-projector comprises a light emitting diode (LED) light source and a projection matrix.

25. The integrated keyboard and video projection device of claim 24 wherein said LED light source is a high brightness white-light LED.

26. The integrated keyboard and video projection device of claim 24, wherein said LED light source comprises an RGB LED arrangement.

27. The integrated keyboard and video projection device of claim 26, wherein said RGB LED arrangement comprises a single LED device providing red, green, and blue light sources.

28. The integrated keyboard and video projection device of claim 26, wherein said RGB LED arrangement comprises a red LED, a green LED and a blue LED.

29. The integrated keyboard and video projection device of claim 24, wherein said projection matrix is one of a reflective LCD, LCOS, and DLP matrix.

30. The integrated keyboard and video projection device of claim 24, wherein said projection matrix is a transmissive LCD matrix.

31. The integrated keyboard and video projection device of claim 17, wherein said mini-projector is configurable for projection in a front projection and rear projection modes.

32. The integrated keyboard and video projection device of claim 17, wherein said keyboard comprises a folding mechanism for folding said keyboard.

33. The integrated keyboard and video projection device of claim 17, wherein said keyboard comprises standard QWERTY keys.

34. A portable computer comprising: a computer enclosure; a mini-projector situated within said computer enclosure and projecting video images; a foldable screen mounted onto said computer enclosure; and, a projection mirror reflecting said video images onto the backside of said foldable screen.

35. The portable computer of claim 34, further comprising a virtual keyboard system.

36. The portable computer of claim 34, further comprising a retractable arm supporting said projecting mirror.

37. The portable computer of claim 34, wherein said foldable screen comprises a diffusive material.

38. The portable computer of claim 37, wherein said foldable screen further comprises an ambient light absorbing layer.

39. The portable computer of claim 34, wherein said foldable screen further comprises a flexible wire frame.

40. The portable computer of claim 34, wherein said mini-projector comprises a light emitting diode light (LED) source and a projection matrix.

41. The portable computer of claim 40 wherein said LED light source is a high brightness white-light LED.

42. The portable computer of claim 40, wherein said LED light source comprises an RGB LED arrangement.

43. The portable computer of claim 42, wherein said RGB LED arrangement comprises a single LED device providing red, green, and blue light sources.

44. The portable computer of claim 42, wherein said RGB LED arrangement comprises a single LED device providing red, green, and blue light sources.

45. The portable computer of claim 40, wherein said projection matrix is one of a reflective LCD, LCOS, and DLP matrix.

46. The portable computer of claim 40, wherein said projection matrix is a transmissive LCD matrix.

47. The portable computer of claim 17, wherein said mini-projector is configurable for projection in a front projection and rear projection modes.
